(19) United States
(12) Patent Application Publication
(10) Pub. No.: US 2024/0055780 A1
(43) Pub. Date: Feb. 15, 2024

(54) DIPOLE RADIATOR, A DUAL-POLARIZED CROSS DIPOLE COMPRISING TWO DIPOLE RADIATORS AND A MOBILE COMMUNICATION ANTENNA COMPRISING A PLURALITY OF DUAL-POLARIZED CROSS DIPOLES

(71) Applicant: Telefonaktiebolaget LM Ericsson (publ), Stockholm (SE)

(72) Inventors: Andreas Vollmer, Rosenheim (DE); Dan Fleancu, Griesstätt (DE)

(21) Appl. No.: 18/279,846

(22) PCT Filed: Mar. 8, 2021
(86) PCT No.: PCT/EP2021/055765

§ 371 Date: Aug. 31, 2023

(51) Int. Cl. H01Q 25/00; H01Q 1/24; H01Q 9/20; H01Q 9/28

(52) U.S. Cl. CPC H01Q 25/001; H01Q 1/246; H01Q 9/20; H01Q 9/28

(57) ABSTRACT

Dipole radiator comprising a first and second carrier and a signal feeding structure. The first and second carriers comprise a sup-port sections with a first and second end and a wing sections. The support sections of the first and second carriers each comprise an inner side which face each other and an opposite outer side. The signal feeding structure comprises a feed section, a connecting section and an end section. The feed section runs along the inner side of the support section goes into the connection section which goes into the end section. The end section runs along the out-er side of the support section of the second carrier.

### TECHNICAL FIELD

The invention relates to a dipole radiator, a dual-polarized cross dipole comprising two dipole radiators and a mobile communication antenna comprising a plurality of dual-polarized cross dipoles.

### BACKGROUND

A mobile communication antenna comprises a plurality of antenna elements. Those antenna elements often comprise dual-polarized dipoles. In order to achieve a compact design and high data rates both polarizations must be isolated from each other. The isolation should be higher than 30 dB. A dual-polarized cross dipole is known from the U.S. Pat. No. 6,072,439A. This dual-polarized cross dipole comprises of two dipole radiators each having two dipole wings and a printed circuit board which is used for the signal feeding.

### SUMMARY

An object of the present invention is seen in simplifying the manufacture of a dipole radiator and therefore of a dual-polarized cross dipole and the mobile communication antenna itself. In addition, the isolation between two polarizations should be enhanced.

The object is solved by a dipole radiator according to claim 1 and a dual-polarized cross dipole according to claim 11 and a mobile communication antenna according to claim 16. Claims 2 to 10 describe further embodiments of the dipole radiator, wherein claims 12 to 15 describe further embodiments of the dual-polarized cross dipole.

The dipole radiator according to the present invention is used for the dual-polarized cross dipole and therefore for mobile communication antenna. A first and the second carrier and a signal feeding structure are provided. The first carrier comprises a support section and a wing section. The support section has a first end adapted to be arranged on and extending away from a base plate. The base plate could be a reflector arrangement for example. The support section also has a second end which goes into third wing section. The wing section extends at an angle (for example 90°) to and away from said support section. The same is also true for the second carrier. The second carrier comprises a support section and a wing section. The support section also has a first end and can be arranged on a base plate. The base plate could be a reflector arrangement. The support section extends away from the base plate and comprises a second end which merges with said wing section that also extends at an angle (preferably 90°) to and away from said support section. The wing sections of the first and the second carriers extend at least partially in opposite directions. The support sections of the first and the second carriers each comprise an inner side and an opposite outer side. The inner sides of the support section of the first and second carriers face each other. The signal feeding structure comprises a feed section, a connecting section and an end section. The feed section of the signal feeding structure extends between the support sections of the first and the second carriers along the inner side of the support section of the first carrier and merges with the connection section. The feed section is preferably arranged closer to the inner side of the support section of the first carrier than to the inner side of the support section of the second carrier. The connecting section extends from the region of the second end of the support section of the first carrier towards the second end of the support section of the second carrier and merges in that region into the end section. In addition, the end section runs along the outer side of the support section of the second carrier in direction of its first end.

It is very beneficial that both inner sides of the support sections of the first and the second carriers face each other and that the signal feeding structure runs along the inner side of the support section of the first carrier and runs along the outer side of the support section of the second carrier. This results in a compact feed an enhanced port-to-port isolation at the reflector level of about 30 dB instead of 20 dB. The dipole radio could also be named a linear polarized dipole radiator.

In a further embodiment, a vector of an E-field between the feed section of the signal feeding structure and the support section of the first carrier points in approximately the same direction as the vector of an E-field between the end section of the signal feeding structure and a support section of the second carrier. In that case, a very symmetrical architecture, symmetrical field distribution and symmetrical radiation pattern is achieved contributing to the high port-to-port isolation.

In another embodiment, the second carrier comprises an opening in the region of the second end of the support section through which the signal feeding structure is fed. This feature astonishingly contributes to the isolation, because no changes in the way the signal feeding structure runs or in the way the second carrier runs have to be made. A compact design is still achieved.

In another embodiment, the opening could be open to one side so that the signal feeding structure can be inserted into the opening with a movement vector transverse to the extension of the support section of the second carrier. In other words, the signal feeding structure can be inserted sideways. However, the opening could also be bounded in the circumferential direction by the second carrier and is thus closed, so that the signal feeding structure can be inserted into the opening preferably only with a movement vector predominantly parallel to the extension of the support section of the second carrier. In that case, the signal feeding structure would be inserted from the top.

In a further embodiment, the feed section of the signal feeding structure is longer than the end section of the signal support structure. In that case, there is an open end arranged next to the outer side of the support section of the second carrier. The open end reduces the negative impact on the far field characteristics.

In another embodiment, the signal feeding structure is punched and/or lasered and/or bent part. Preferably, the signal feeding structure could also be named as microstrip line feed. In addition or alternatively, the first carrier is a punched and/or lasered and/or bent part. in addition or alternatively, the second carrier is a punched and/or lasered and/or bent part. Preferably, the signal support structure, the first carrier and/or the second carrier consist of or comprise metal or a metal alloy. These features allow that the dipole radiator could easily be manufactured.

In another embodiment, the signal feeding structure is only capacitively coupled to the respective first and second carrier. In that case, there is no inductive or galvanic coupling. More preferably, the feed section could be capacitively coupled or galvanically connected to a signal line, and therefore to a phase shifter arrangement. The support section of the first and/or second carrier could also be capacitively coupled or galvanically connected to a ground layer. This capacitive coupling or the galvanic connection would be achieved at the first end of the support section of the first and/or second carrier.

In another embodiment, the support section of the first carrier is wider along its predominant length than the feed section of the signal support structure. Therefore, an optimal coupling is achieved. The thickness of both, the support section of the first carrier and the feed section of the signal feeding structure could be the same. In addition or alternatively, the support section of the second carrier is wider along its predominant length than the end section of the signal support structure. The thickness of both, the support section of the second carrier and the end section of the signal feeding structure could be the same.

In another embodiment, the feed section of the signal feeding structure comprises segments with a different width. This results in a higher matching potential.

In another embodiment, a part of the wing section of the first carrier comprises a printed circuit board or a metallized substrate. In addition or alternatively, a part of the wing section of the second carrier comprises a printed circuit board or a metallized substrate. In that case more complex structures can be realized, e.g. for enhanced filtering, transparency towards higher frequencies or bandwidth. In that case, high band radiators could be placed underneath the dual-polarized cross dipole.

In another embodiment, the wing section of the first carrier is bifurcated. In addition or alternatively, the wing section of the second carrier is bifurcated. This increases the bandwidth or reduces the wing length or changes the farfield characteristics of the dipole radiator. Various wing forms can be imagined and the invention is not limited to a specific wing form, geometry or characteristic. However, the described and/or depicted wing forms achieve good results.

The dual-polarized cross dipole according to the present invention comprises a first dipole radiator and a second dipole radiator. The second dipole radiator is arranged 90° rotated with respect to the first dipole radiator. In that case, the support sections of the first and the second carriers of the first dipole radiator are arranged 90° rotated with respect to the support sections of the first and the second carrier of the second dipole radiator. The connecting section of the signal feeding structure of the first dipole radiator passes under the connecting section of the signal feeding structure of the second dipole radiator. This could also be the other way around. In that case, the connecting section of the signal feeding structure of the second dipole radiator passes under the connecting section of the signal feeding structure of the first dipole radiator. It is very beneficial that the isolation between both polarizations is increased by the use of two dipole radiators as previously described.

In another embodiment, the first and the second carriers of the first dipole radiator and the first and the second carriers of the second dipole radiator comprise at least two coupling surfaces in the region of the second end of their respective support section. The coupling surfaces extend from the region of the second ends of the respective support section (at least) partly in direction of the first end of the respective support section. In other words, the coupling surfaces extend towards the base plate. The coupling surfaces are arranged on two opposite sides of the respective first and second carrier and are angularity aligned with respect to the first and second carrier. In that case, each of the first and second carriers comprise at least two coupling surfaces which are arranged at opposite sides. A capacitive coupling is established between each coupling surface of one dipole radiator and the corresponding coupling surface of the outer dipole radiator. To be more precisely, a first coupling surface of the first carrier of the first dipole radiator is arranged at least partially parallel (spaced apart) and adjacent to a first coupling surface of the first carrier of the second dipole radiator, thereby forming a capacitive coupling between both coupling surfaces. A second coupling surface of the first carrier of the first dipole radiator is arranged at least partially parallel (spaced apart) and adjacent to a second coupling surface of the second carrier of the second dipole radiator, thereby forming a capacitive coupling between both coupling surfaces. A first coupling surface of the second carrier of the first dipole radiator is arranged at least partially parallel (spaced apart) and adjacent to a first coupling surface of the second carrier of the second dipole radiator, thereby forming a capacitive coupling between both coupling surfaces. A second coupling surface of the second carrier of the first dipole radiator is arranged at least partially parallel (spaced apart) and adjacent to a second coupling surface of the first carrier of the second dipole radiator, thereby forming a capacitive coupling between both coupling surfaces. In that case, an integrated LC-matching is provided which in turn improves the bandwidth. Compared to prior art sheet-metal dipole designs, the c (capacitive) integrated matching geometry is not any more in the dipole aim plane or realized on a PCB (printed circuit board). As a result, the matching structure impact on the far field characteristics and the matching structure impact on the interleaved radiators that work on higher frequencies is now lower.

In another embodiment, some or all of the coupling surfaces comprise coupling fingers at their ends remote from the central axis. The coupling fingers of two adjacent coupling surfaces are bent towards each other and engage into each other without any contact. The coupling fingers are located away from that part of the first and second carrier to which the coupling surface is attached to.

In another embodiment, a holding device is provided. The holding device could comprise a ground part which is attachable to the base plate (for example the reflector arrangement) and which is configured to support the first and the second carriers of the first and the second dipole radiators in the region of the first end of their respective support sections. Preferably only one ground part is used. The holding device could also comprise a head part which is configured to hold the first and the second carriers of the first and the second dipole radiators in the region of the second end of their respective support sections. The head part would comprise coupling elements which are inserted between two adjacent coupling surfaces of different dipole radiators so as to affect the capacitive coupling.

In another embodiment, the support sections of the first and second carriers of the first dipole radiator are joined together at their first ends and are formed in one piece. In that case, the first and the second carriers are of an integral form. In addition or alternatively, the support sections of the first and second carriers of the second dipole radiator are joined together at their first ends and are formed in one piece. In that case, the first and the second carriers are of an integral form. However, it could also be possible that the support section of the first carrier of the first dipole radiator is integrally connected at the first end to the first end of the support section of the first or second carrier of the second dipole radiator, respectively. In addition or alternatively, the support section of the second carrier of the first dipole radiator is integrally connected at the first end to the first end of the support section of the second or first carrier of the second dipole radiator. Alternatively, the support sections of the first and second carriers of the first and second dipoles radiators are all integrally connected to each other at their first ends. By using an integral connection the number of single parts is reduced. This results in advantages in the production process.

The mobile communication antenna according to the present invention has a plurality of dual-polarized cross dipoles. Furthermore, a reflector arrangement is provided. The reflector arrangement could be made of a single electrically conductive plate or of a plurality of plates which are electrically conductive. The plurality of dual-polarized cross dipoles are arranged on a first side of the reflector arrangement. They are arranged in n columns, with n≥2, 3, 4, 5, 6, 7, 8, wherein in each column m dual-polarized cross dipoles are provided, with m n≥2, 3, 4, 5, 6, 7, 8, 12, 16, 20. Furthermore, a phase shift arrangement and the filter arrangement are arranged in a second side of the reflector arrangement. The phase shifter arrangement is preferably connected to the feed sections of the first and second dipole radiators which form the respective dual-polarized cross dipoles. Between the phase shift arrangement and the respective feed sections, a distribution and/or filter network could be arranged. Furthermore, at least one power amplifier for each polarization and at least one lower noise amplifier for each polarization could also be provided on the second side of the reflector arrangement.

The dipole radiator can especially be used in the frequency range of 698 MHz to 960 MHz.

### BRIEF DESCRIPTION OF THE DRAWINGS

Different embodiments of the invention will be described in the following, by way of example and with reference to the drawings. The same elements are provided with the same reference signs. The figures show in detail:

FIG. 1A: a dipole radiator according to one embodiment of the present invention;

FIG. 1B: a longitudinal section view through the dipole radiator of FIG. 1A;

FIG. 2A: a dipole radiator according to another embodiment of the present invention;

FIG. 2B: a longitudinal section view through the dipole radiator of FIG. 2A;

FIG. 3: a dual-polarized cross dipole according to one embodiment of the present invention comprising a first and a second dipole radiator according to FIGS. 1A, 1B;

FIG. 4: a holding device comprising a ground part which is used to hold the dual-polarized cross dipole;

FIGS. 5A, 5B, 5C: various embodiments of the dual-polarized cross dipole describing the use of coupling surfaces for establishing a capacitive coupling between the coupling surfaces of two neighboring dipole radiators;

FIGS. 6A, 6B, 6C: various embodiments of the dual-polarized cross dipole comprising declined wing sections or wing sections made of the printed circuit board arrangement;

FIG. 7: and embodiment of a part of a dipole radiator, wherein a feed section of the signal feeding structure comprises segments with a different width;

FIGS. 8A, 8B: another embodiment of the holding device comprising a ground part and a head part;

FIG. 9: another embodiment of the dual-polarized cross dipole, wherein the wing sections are bifurcated;

FIG. 10: another embodiment of a dipole radiator, wherein an opening at the second end 8b of the support section 8 of the second carrier 6 is accessible from the side; and

FIGS. 11A, 11B: further embodiments of a mobile communication antenna having a plurality of dual-polarized cross dipoles.

### DETAILED DESCRIPTION

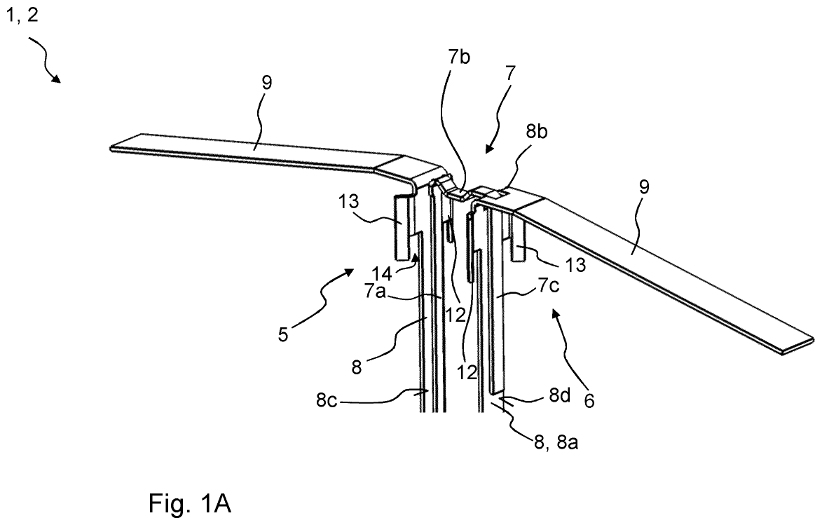

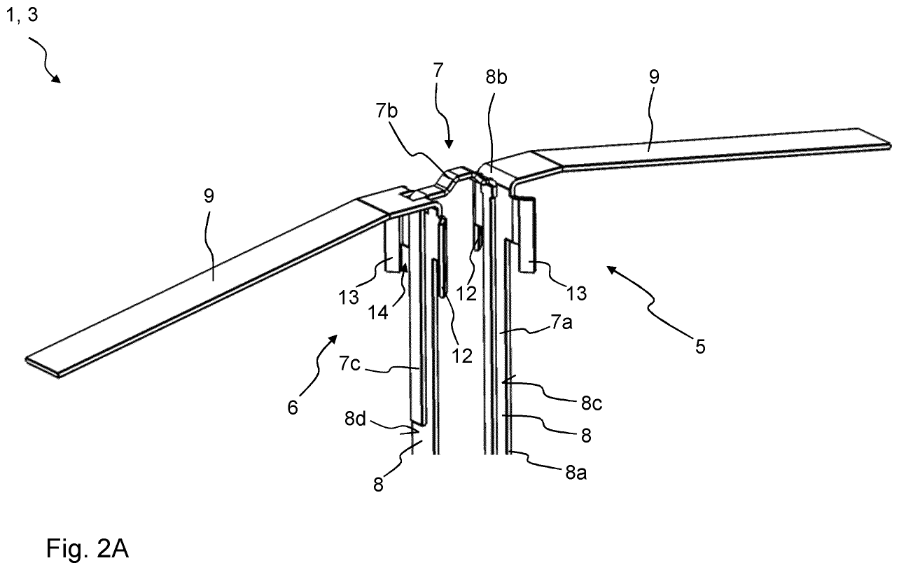

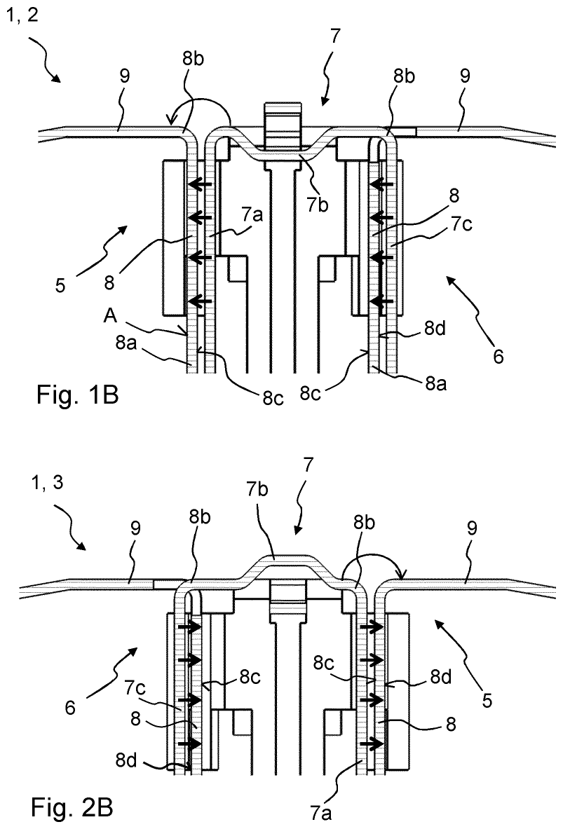

FIG. 1A shows a dipole radiator 1 for a dual-polarized cross dipole 50 for a mobile communication antenna 100. Within FIG. 1A a dipole radiator 1 in form of a first dipole radiator 2 is shown. Within FIG. 2A a dipole radiator 1 in form of a second dipole radiator 3 is shown. The explanations made in the following apply to the first dipole radiator 2 as well as to the second dipole radiator 3. The first and the second dipole radiator 2, 3 are used as explained below to form the dual-polarized cross dipole 50.

The dipole radiator 1 and therefore the first dipole radiator 2 and the second dipole radiator 3 comprises a first carrier 5, a second carrier 6 and a signal feeding structure 7. The first carrier 5 comprises a support section 8 and a wing section 9. The first carrier 6 also comprises a support section 8 and a wing section 9. The support section 8 of the first and second carrier 5, 6 has a first end 8a and a second end 8b. The support section 8 can be arranged on a base plate (for example a reflector arrangement) with its first end 8a. The support section 8 then protrudes from the base plate 10. At the second end 8b, the support section 8 merges into the wing section 9. The wing section 9 is orientated parallel or with a component predominantly parallel to the base plate 10. The wing section 9 extends at an angle (for example 90°) to and away from the respective support section 8. In other words, the first and the second carrier 5, 6 each comprise the support section 8 and the wing section 9 which are arranged angular to each other. The wing sections 9 of the first and second carriers 5, 6 extend (over their entire length) fully or at least partially in opposite directions.

The support sections 8 of the first and the second carriers 5, 6 each comprise an inner side 8c and an opposite outer side 8d. The inner sides 8c of the support sections 8 of the first and second carriers 5, 6 are directed towards each other, thereby facing each other. The signal feeding structure 7 comprises a feed section 7a, a connecting section 7b and an end section 7c.

The feed section 7a of the signal feeding structure 7 is arranged between the support sections 8 of the first and second carriers 5, 6. The feed section 7a extends between the support sections 8 of the first and second carriers 5, 6 along the inner side 8c of the support section 8 of the first carrier 5 and merges into the connecting section 7b. In other words, the feed section 7a runs along the inner side 8c of the support section 8 of the first carrier 5. Preferably, the feed section 7a is aligned parallel to the support section 8 of the first carrier 5 over a predominant part of its length or over its full length. A distance between the feed section 7a and the support section 8 of the first carrier 5 is preferably the same over a predominantly part of the length or over the full length of the feed section 7a.

The connecting section 7b extends from the region of the second end 8b of the support section 8 of the first carrier 5 towards the second end 8b of the support section 8 of the second carrier 6. In that region (second end 8b of the support section 8 of the second carrier 6) the connecting section 7b merges into the end section 7c.

The end section 7c of the signal feeding structure 7 runs along the outer side 8d of the support section 8 of the second carrier 6 in the direction of the first end 8a of the support section 8 of the second carrier 6. Preferably, the end section 7c comprises an open end which means that the end section 7c is not coupled and/or galvanically connected to another structure (except the coupling towards the support section 8 of the second carrier 6). More preferably, the end section 7c ends at a distance spaced apart from the base plate 10. In that case, the feed section 7a is longer than the end section 7c. The distance is preferably larger than 0.1λ, 0.2λ, 0.3λ, 0.4λ or larger than 0.5λ, but preferably smaller than 0.7λ, 0.6λ, 0.5λ, 0.4λ, 0.3λ or smaller than 0.2λ. The end section 7c of the signal feeding structure 7 is preferably larger than 0.01λ, 0.03λ, 0.07λ, 0.1λ, 0.12λ, 0.16λ, 0.2λ, 0.25λ or larger than 0.3λ. The end section 7c of the signal feeding structure 7 is preferably smaller than 0.3λ, 0.26λ, 0.23λ, 0.19λ, 0.15λ, 0.13λ, 0.11λ, 0.09λ or smaller than 0.5λ. λ is the wavelength corresponding to the mid-frequency of the frequency band the dipole radiator 1, 2, 3 is used for and the magnitude of the phase velocity of the medium surrounding the dipole radiator 1, 2, 3.

The distance between the end section 7c and the support section 8 of the second carrier 6 stays preferably the same over the predominantly part of the length of the end section 7c or it stays the same over the entire length of the end section 7c.

Preferably, the signal feeding structure 7 is arranged in a single plane. In order that the feed section 7a of the signal feeding structure 7 can be arranged next to the inner side 8c of the support section 8 of the first carrier 5 and in order that the end section 7c of the signal feeding structure 7 can be arranged next to the outer side 8d of the support section 8 of the second carrier 6, the second carrier comprises an opening 11 through which the signal feeding structure 7 passes. The opening 11 is preferably arranged in the region of the second end 8b of the support section 8 of the second carrier 6. The opening could be arranged in a preferably curved transition between the support section 8 of the second carrier 6 and the wing section 9 of the second carrier 6. FIGS. 1A, 2A show that the opening 11 is enclosed on all sides in this circumferential direction and is therefore bounded by the second carrier 6. As such, it would not be possible to insert a part of the signal feeding structure 7 with a movement vector perpendicular to the longitudinal axis of the support section 8 of the second carrier 6. This opening 11 allows that the signal feeding structure 7 is arranged in a single plane. The electrical properties are therefore enhanced compared to other solutions in which this would not be the case. Referring now to FIG. 10, it can be seen that the opening 11 is open to one side so that the signal feeding structure 7 can be inserted into the opening 11 with a movement vector perpendicular to the longitudinal axis of the support section 8 of the second carrier 6. In that regard, a part of the wing section 9 of the second carrier 6 that starts at the second end 8b of the support section 8 of the second carrier 6 is preferably L-shaped.

When looking at the first dipole radiator 2 in FIG. 1A for example, it can be seen that the connecting section 7b of the signal feeding structure 7 lowers in the middle (preferably below the plane which runs through the wing sections 9). When looking at the second dipole radiator 3 in FIG. 2B for example, it can be seen that the connecting section 7b of the signal feeding structure 7 rises in the middle (preferably above the plane which runs through the wing sections 9). In that case the signal feeding structures 7 of both, the first dipole radiator 2 and the second dipole radiator 3 can cross each other at an angle of approximately 90°. A high isolation is thereby achieved. The feed section 7a of the signal feeding structure 7 of the first dipole radiator 2 and the feed section 7a of the signal feeding structure 7 of the second dipole radiator 3 are preferably spaced apart by less than 6 mm, 5 mm, 4 mm or less than 3 mm. The feed section 7a of the signal feeding structure 7 of the first dipole radiator 2 and the feed section 7a of the signal feeding structure 7 of the second dipole radiator 3 are preferably spaced apart by more than 1 mm or more than 2 mm. The wording spaced apart is preferably directed to the minimum or average gap between the two feed sections 7a.

Referring back to FIGS. 1A, 2B and 10, the first and second carriers 5, 6 of the first dipole radiator 2 and the first and second carriers 5, 6 of the second dipole radiator 3 comprise at least two coupling surfaces 12, 13. The coupling surfaces 12, 13 are arranged in the region of the second end 8b of the respective support section 8 of the first and second carrier 5, 6. The coupling surfaces 12, 13 are used to establish a capacitive coupling between the coupling surface 12, 13 of one carrier 5, 6 of one dipole radiator 2, 3 to neighboring coupling surface 12, 13 of one carrier 5, 6 of the other dipole radiator 3, 2. Preferably every carrier 5, 6 comprises two coupling surfaces 12, 13. There could also be only one coupling surface 12, 13 or more than two coupling surfaces 12, 13.

In other words, one carrier 5, 6 or two carriers 5, 6 of the first dipole radiator 2 is or are capacitively coupled to one or two carriers 5, 6 of the second dipole radiator 3. This is preferably done by coupling surfaces 12, 13 which are part of the respective carrier 5, 6 and which are bent towards the respective carrier 5, 6 of the other dipole radiator 2, 3.

Two neighboring coupling surfaces 12, 13 which establish a capacitive coupling to each other are spaced apart by preferably more than 1 mm, 2 mm, 3 mm, 4 mm, 5 mm or by more than 6 mm More preferably, the distance is less than 7 mm, 6 mm, 5 mm, 4 mm, 3 mm or less than 2 mm.

Preferably, the coupling surfaces 12, 13 are part of the support section 8 of the respective first or second carrier 5, 6. In addition or alternatively, they could also be part of the wing section 9 of the respective first and second carrier 5, 6.

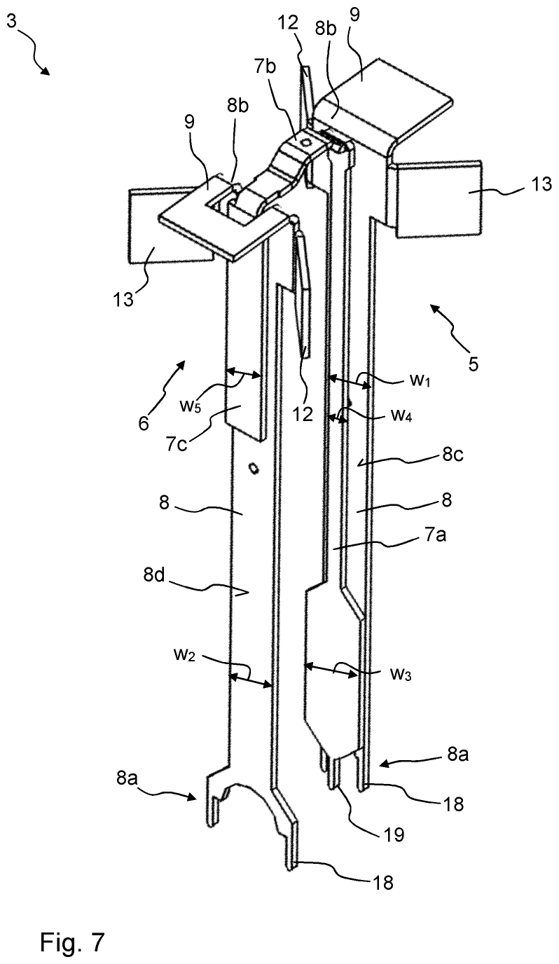

The coupling surfaces 12, 13 enlarge the respective part of the carrier 5, 6 (for example the support section 8) to which they are attached to the side. In the examples shown, the width of the support section 8 increases preferably to both sides, because two coupling surfaces 12, 13 are used. The coupling surfaces 12, 13 are arranged on opposite sides of the respective support section 8 (or the respective wing section 9). More precisely, the coupling surfaces 12, 13 comprise a first part which extends sideways and a second part which extends towards the base plate 10. Between the second part and the respective support section 8, there could be a recess 14. However, such a recess is only optional as the embodiments of FIGS. 7 and 10 lack such a recess.

In order to establish the capacitive coupling, a first coupling surface 12 of the first carrier 5 of the first dipole radiator 2 is arranged at least in part or fully parallel and spaced apart to a first coupling surface 12 of the first carrier 5 of the second dipole radiator 3.

More preferably, a second coupling surface 13 of the first carrier 5 of the first dipole radiator 2 is arranged at least in part or fully parallel and spaced apart to a second coupling surface 13 of the second carrier 6 of the second dipole radiator 3.

More preferably, a capacitive coupling, a first coupling surface 12 of the second carrier 6 of the first dipole radiator 2 is arranged at least in part or fully parallel and spaced apart to a first coupling surface 12 of the second carrier 6 of the second dipole radiator 3.

More preferably, a second coupling surface 13 of the second carrier 6 of the first dipole radiator 2 is arranged at least in part or fully parallel and spaced apart to a second coupling surface 13 of the first carrier 5 of the second dipole radiator 3.

It is now referred to FIGS. 1B and 2B which show longitudinal section views through the first and second dipole radiator 2, 3. As can be seen, a vector of an E-field (black arrows) between the feed section 7a of the signal feeding structure 7 and the support section 8 of the first carrier 5 points in approximately the same direction as a vector of an E-field (black arrow) between the end section 7c of the signal feeding structure 7 and the support section 8 of the second carrier 6. As such, the architecture is very symmetrical.

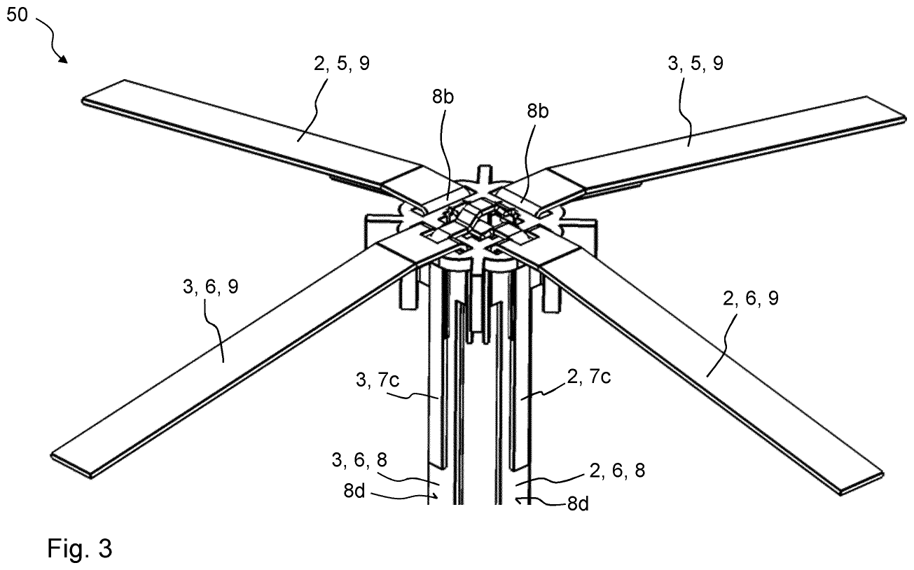

FIG. 3 shows an embodiment of the dual-polarized cross dipole 50 for mobile communication antennas. The dual-polarized cross dipole 50 is configured to transmit and receive mobile communication signals into polarizations. Polarizations could be for example linear +45°/−45° slant, linear 0°/90° horizontal and vertical.

The dual-polarized cross dipole 50 comprises a first dipole radiator 2 (as described above) and a second dipole radiator 3 (as described above). The second dipole radiator 3 is arranged 90° rotated with respect to the first dipole radiator.

Both dipole radiators 2, 3 are preferably arranged around a common center. In other words, the support sections 8 of the first and second carriers 5, 6 of the first dipole radiator 2 are arranged 90° rotated with respect to the support sections 8 of the first and second carriers 5, 6 of the second dipole radiator 3. The connecting section 7b of the signal feeding structures 7 of the first dipole radiator 2 passes under the connecting section 7b of the signal feeding structure 7 of the second dipole radiator 3. This could also be done vice versa. In that case, the connecting section 7b of the signal feeding structure 7 of the second dipole radiator 3 passes under the connecting section 7b of the signal feeding structure 7 of the first dipole radiator 2.

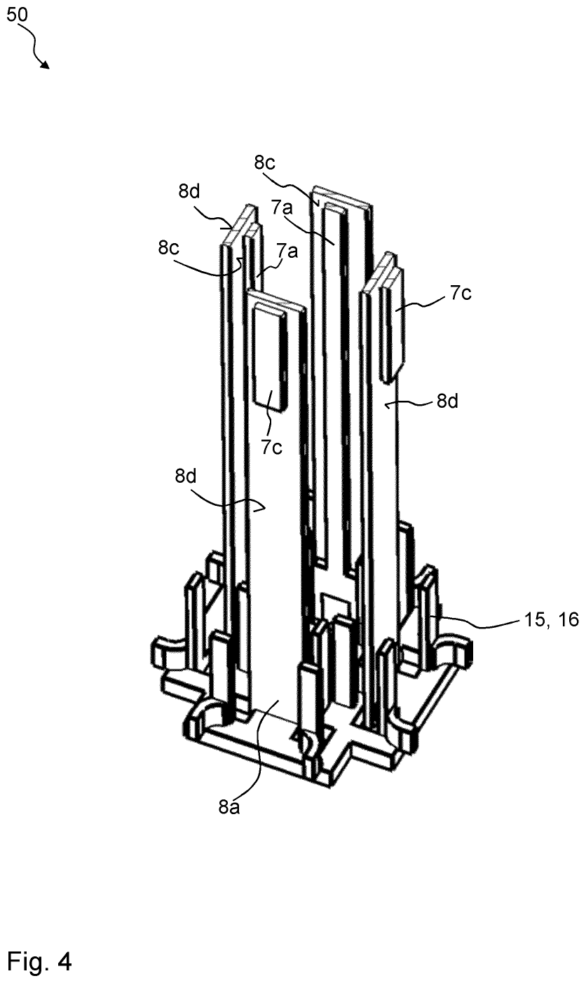

FIG. 4 shows the holding device 15 which comprises a ground part 16. The ground part 16 is attachable to the base plate 10 and configured to hold the first and the second carriers 5, 6 of the first and second dipole radiators 2, 3. The ground part 16 is preferably attached to the base plate 10 by using a snap in connection. The ground part 16 is preferably made of a dielectric material or comprises a dielectric material and is more preferably made of plastic or comprises plastic. The ground part 16 is preferably made of a single piece.

The first and the second carriers 5, 6 are hold at their lower end (the first end 8a of the respective support section 8). More preferably, the ground part 16 comprises slots into which the respective support sections 8 of the first and second carrier 5, 6 of the first and second dipole radiators 2, 3 and/or into which the feed sections 7a of the signal feeding structures 7 of the first and second dipole radiators 2, 3 can be inserted.

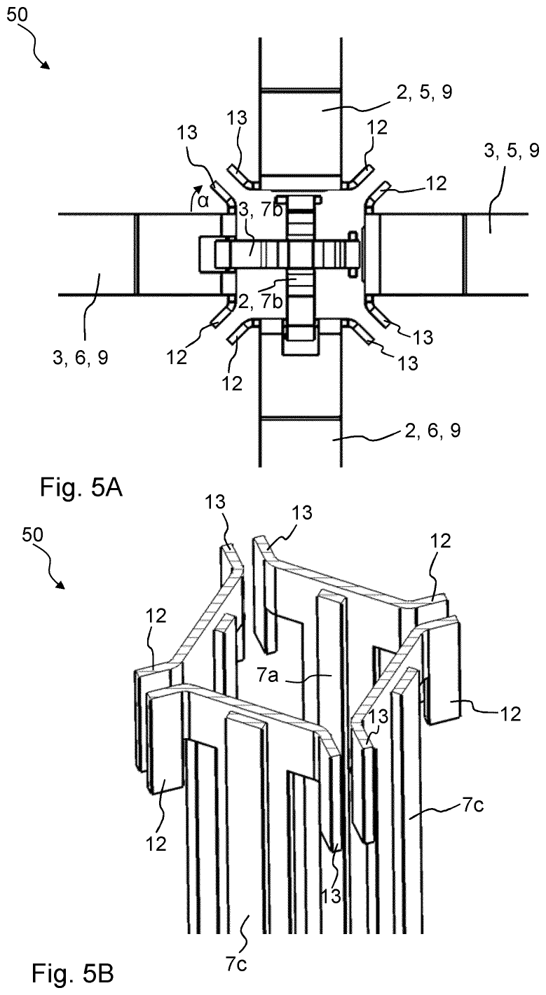

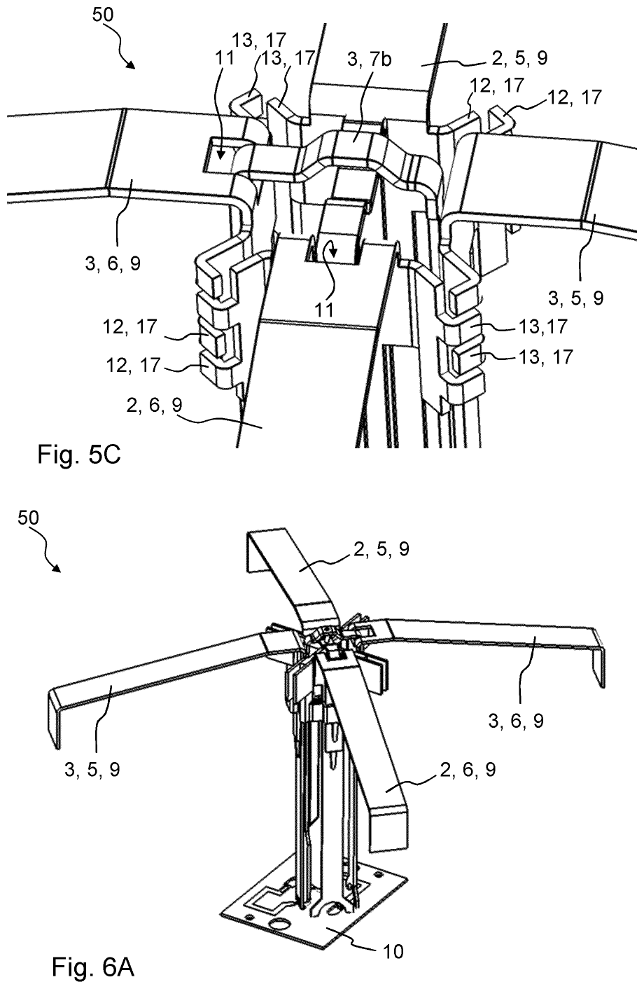

FIGS. 5A and 5B show different views of the dual-polarized cross dipole 50. It can be seen that the coupling surfaces 12, 13 form an angle α of about 45° towards the respective wing section 9 of the first or second carrier 5, 6 of the first or second dipole radiator 2, 3. Preferably, the coupling surfaces 12, 13 of the first dipole radiator 2 would form an angle α of about 45° towards a plane which extends through the first and second carrier 5, 6 of the first dipole radiator 3. More preferably, the coupling surfaces 12, 13 of the second dipole radiator 2 would form an angle α of about 45° towards a plane which extends through the first and second carrier 5, 6 of the second dipole radiator 3.

FIG. 5C shows another embodiment of the dual-polarized cross dipole 50. In that embodiment, all of the coupling surfaces 12, 13 of the first and second carrier 5, 6 of the first and second dipole radiator 2, 3 comprise coupling fingers 17. The coupling fingers 17 of two adjacent coupling surfaces 12, 13 which form a capacitive coupling are bent towards each other and engage into each other without contact. The coupling fingers 17 are preferably located at the respective ends of the coupling surfaces 12, 13 which are remote from the central axis. The coupling fingers 17 are therefore located at a side of the respective coupling surfaces 12, 13, wherein the side preferably extends parallel to the longitudinal axis of the support section 8 of the respective first or second carrier 5, 6 the coupling surfaces 12, 13 are attached to. Two coupling fingers 17 of this same coupling surface 12, 13 are spaced apart thereby forming a recess into which a coupling finger 17 of another coupling surface 12, 13 engages. Preferably all coupling surfaces 12, 13 have the same amount of coupling fingers 17. More preferably, every coupling surface 12, 13 has two, three, four, five or more than five coupling fingers 17. Not all coupling surfaces 12, 13 of the dual-polarized cross radiator 50 need to have coupling fingers 17.

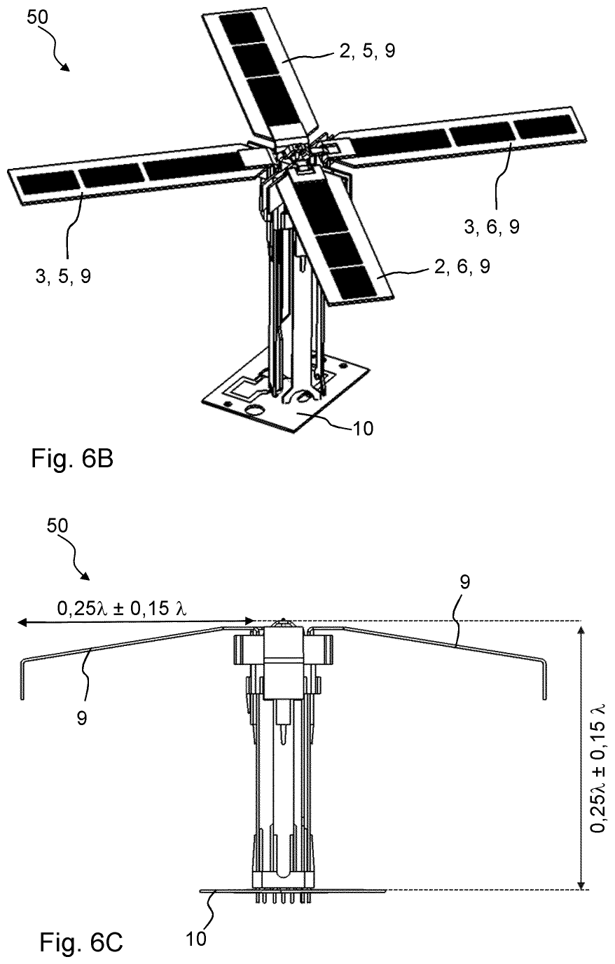

FIG. 6A shows another embodiment of the dual-polarized cross radiator 50. In that case, the wing sections 9 of the first and second carriers 5, 6 of the first and second dipole radiators 2, 3 are declined. Starting from the second end 8b of the respective support section 8 to which the wing sections 9 belongs, a distance towards the base plate 10 is steadily decreased until the end of the wing section 9. More preferably, the end of the wing section 9 could be bent (for example by an angle of approximately 90°, wherein the wording approximately includes deviations of preferably less than 10° or less than 5°) towards the base plate 10.

FIG. 6B shows another embodiment of the dual-polarized cross radiator 50. In that case, a part of the wing sections 9 of the first and second carriers 5, 6 of the first and second dipole radiator 2, 3 are formed as a printed circuit board or as a metallized substrate. More preferably, the predominantly part of wing sections 9 are formed as a printed circuit board or as a metallized substrate. It could also be that the wing section 9 as a whole would be formed as a printed circuit board or as a metallized substrate. Preferably both sides of the printed circuit board or the substrates comprise an electrically conductive layer. This comes with the advantage that more complex structures can be realized on the upper and/or lower side of the wing sections 9. The electrically conductive layer could also be applied on the upper side or on the lower side only. For example, structures used for filtering and/or structures working as capacitively connected segments can be added in the metallization so that radiators (for example patch radiators for higher frequency bands) which are preferably arranged below, namely closer to the base plate 10 have better radiating performances. In that case the wing sections 9 would be more transparent for higher frequencies. In other words, by using such structures it would be harder to energize those structures by the higher frequency fields of the radiators below.

FIG. 6C shows another embodiment of the dual-polarized cross radiator 50. It can be seen that the wing sections 9 are inclined with their open end in the direction of the base plate 10 (for example the reflector arrangement). The open end of the wing sections 9 are in this case bent towards the base plate 10. More preferably the wing sections 9 form at their end an angle of about 90° towards the base plate 10 or towards the plane extending through the base plate 10. The wing sections 9 comprise preferably a length of about 0.25λ±0.15λ. A height of the wing sections 9 above the base plate 10 is preferably 0.25λ±0.15λ. λ is the wave length of the mid-frequency of the frequency band they are used for.

FIG. 7 shows another embodiment of the second dipole radiator 3. It has to be understood, that the following remarks also apply to the first dipole radiator 2. The distance between the feed section 7a and the support section 8 of the first carrier 5 is preferably larger than 0.6 mm, 0.8 mm, 1.0 mm, 1.2 mm or larger than 1.4 mm and more preferably smaller than 1.5 mm, 1.3 mm, 1.1 mm, 0.9 mm or smaller than 0.7 mm Preferably, the distance between the feed section 7a and the support section 8 of the first carrier 5 is 1.0 mm.

The distance between the end section 7c and the support section 8 of the second carrier 6 is preferably larger than 0.6 mm, 0.8 mm, 1.0 mm, 1.2 mm or larger than 1.4 mm and more preferably smaller than 1.5 mm, 1.3 mm, 1.1 mm, 0.9 mm or smaller than 0.7 mm Preferably, the distance between the end section 7c and the support section 8 of the second carrier 6 is 1.0 mm.

A width w₁ of the support section 8 of the first carrier 5 is preferably larger than 4.0 mm, 5.0 mm, 6.0 mm, 7.0 mm, 8.0 mm or larger than 9.0 mm and more preferably smaller than 8.5 mm, 7.5 mm, 6.5 mm, 5.5 mm or smaller than 4.5 mm. More preferably, the width w₁ of the support section 8 of the first carrier 5 is 6.0 mm.

A width w₂ of the support section 8 of the second carrier 6 is preferably larger than 4.0 mm, 5.0 mm, 6.0 mm, 7.0 mm, 8.0 mm or larger than 9.0 mm and more preferably smaller than 8.5 mm, 7.5 mm, 6.5 mm, 5.5 mm or smaller than 4.5 mm More preferably, the width w₂ of the support section 8 of the second carrier 6 is 6.0 mm.

A width w₃ of the feed section 7a in the region of the first end 8a of the support section 8 of the first carrier 5 is preferably larger than 5.0 mm, 6.0 mm, 7.0 mm, 8.0 mm, 9.0 mm or larger than 10.0 mm and more preferably smaller than 9.5 mm, 8.5 mm, 7.5 mm, 6.5 mm or smaller than 5.5 mm More preferably, the width w₃ is 7.5 mm Preferably, the feed section 7a has in the region of the first end 8a of the support section 8 of the first carrier 5 a larger width w₃ than the support section 8 of the first carrier 5. More preferably, the width of the feed section 7a alternates over its length. In that case, the feed section 7a of the signal feeding structure 7 comprises segments with a different with. More preferably, the width of the support section 8 of the first carrier 5 and/or the second carrier 6 is constant over a predominant part of its length.

Preferably, the support section 8 of the first carrier 5 is wider along its predominant length then the feed section 7a of the signal feeding structure 7. More preferably, the support section 8 of the second carrier 6 is wider along its predominant length then the end section 7a of the signal feeding structure 7.

A width w₄ of the feed section 7a, especially in the region of the second end 8b of the support section 8 of the first carrier 5 is preferably larger than 0.5 mm, 1.0 mm, 2.0 mm, 3.0 mm, 4.0 mm or larger than 5.0 mm and more preferably smaller than 5.5 mm, 4.5 mm, 3.5 mm, 2.5 mm or smaller than 1.5 mm More preferably, the width w₄ is 2.0 mm.

Preferably, the average width w₅ of the end section 7c of the signal feeding structure 7 along its length starting from the second end 8b of the support section 8 of the second carrier 6 is larger than the average width w₄ of the feed section 7a of the signal feeding structure 7 along the same length starting from the second end 8b of the support section 8 of the first carrier 5.

It can also be seen that the support sections 8 have pins 18 at their first end which protrude through respective openings in the base plate 10 so that the pins 18 can be soldered to the other side (second side) of the base plate 10. In addition or alternatively, the feed section 7a of the signal feeding structure 7 could also comprise at least one pin 19 at the free end which could also protrude through the base plate 10 so that it can be soldered to the other side (second side) of the base plate 10. However, the free end of the feed section 7a could also be bent by approximately an angle of 90° so that it can be soldered to the top side of the base plate (first side) where the dipole radiators 2, 3 are mounted.

The length of the end section 7c of the signal feeding structure 7 is more preferably between 0.05λ and 0.25λ. The length and width is depending on the form of the wing section 9, the coupling surfaces 12,13, the length and width of the other segments of 7 and the environment around the dipole radiator.

The support sections 8 of the first and/or second carrier 6 are preferably arranged perpendicular or with the component predominantly perpendicular to the base plate 10. Deviations of less than 15°, 10° or less than 5° are possible.

In that embodiment, the support sections 8 of the first and second carriers 5, 6 of each of the first dipole radiators 2, 3 are not connected to each other. However, it would also be possible, that the support sections 8 of the first and second carriers 5, 6 of the first dipole radiator 2 are joined together at their first ends 8a and are formed in one piece. In addition or alternatively, it would also be possible, that the support sections 8 of the first and second carriers 5, 6 of the second dipole radiator 3 are joined together at their first ends 8a and are formed in one piece.

It could also be that the support section 8 of the first carrier 5 of the first dipole radiator 2 is integrally connected at the first end 8a to the support section 8 of the first or second carrier 5, 6 of the second dipole radiator 3. In addition or alternatively, the support section 8 of the second carrier 6 of the first dipole radiator 2 is integrally connected at the first end 8a to the first end 8a of the support section 8 of the second or first carrier 6, 5 of the second dipole radiator 3. Alternatively, the support sections 8 of the first and second carriers 5, 6 of the first and second dipole radiators 2, 3 are all integrally connected to each other at their first ends 8a.

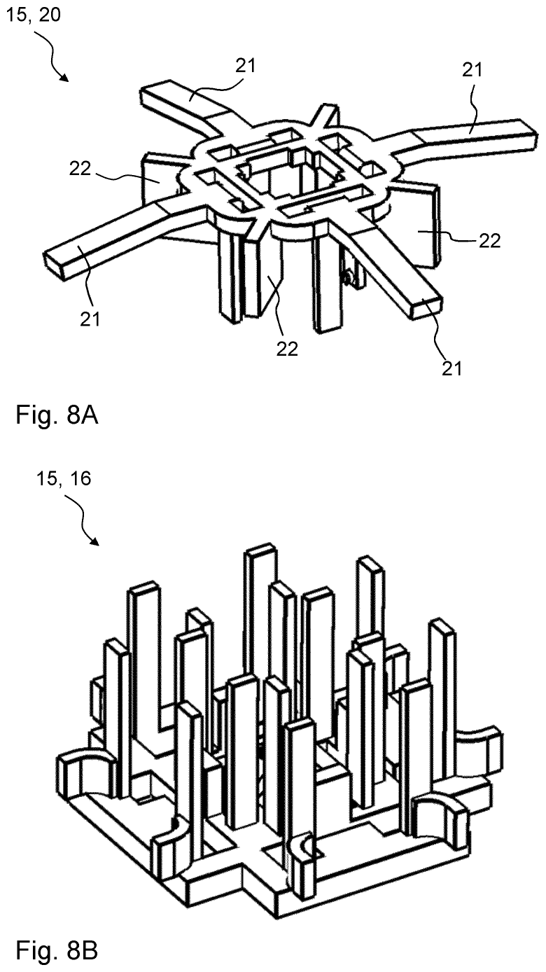

FIG. 8A shows again the holding device 15. This time a head part 20 of the holding device 15 is shown. The head part 20 is configured to hold the first and the second carriers 5, 6 of the first and second dipole radiators 2, 3 in the region of the second end 8b of the respective support sections 8. The head part 20 is preferably attached to the first and second carriers 5, 6, especially by using a snap in connection. In addition or alternatively, the head part 20 could also be attached to the signal feeding structure 7. This could also be done by using a snap in connection. However, the signal feeding structure 7 could also be attached to the first and/or second carrier 5, 6, especially by the use of a snap in connection. The head part 20 is preferably made of a dielectric material or comprises a dielectric material and is more preferably made of plastic or comprises plastic. The head part 20 is preferably made of a single piece.

The head part 20 preferably comprises openings through which the respective support sections 8 of the first and second carriers 5, 6 of the first and second dipole radiators 2, 3 and the respective feed sections 7a and end sections 7c of the first and second dipole radiators 2, 3 can be inserted. More preferably, the head part 20 preferably also comprises support surfaces 21 on which the respective wing sections 9 rest. The support surfaces 20 may be bent towards the base plate 10.

The head part 20 preferably also comprises dielectric elements 22 which can be positioned between two coupling surfaces 12, 13 of the first and second carriers 5, 6 of the first and second dipole radiators 2, 3. Those dielectric elements 22 are preferably plate-shaped. They preferably consist of or comprise the same material as the rest of the head part 20. However, the dielectric elements 22 could also consist of or comprises a different material compared to the rest of the head part 20. The use of dielectric elements 22 is optional.

The head part 20 preferably comprises or consists of Polytetrafluorethylen.

FIG. 8B shows again the ground part 16. Reference is made to the explanations regarding FIG. 4. The ground part 16 and the head part 20 are preferably separate pieces. However, they could also be built by a single piece.

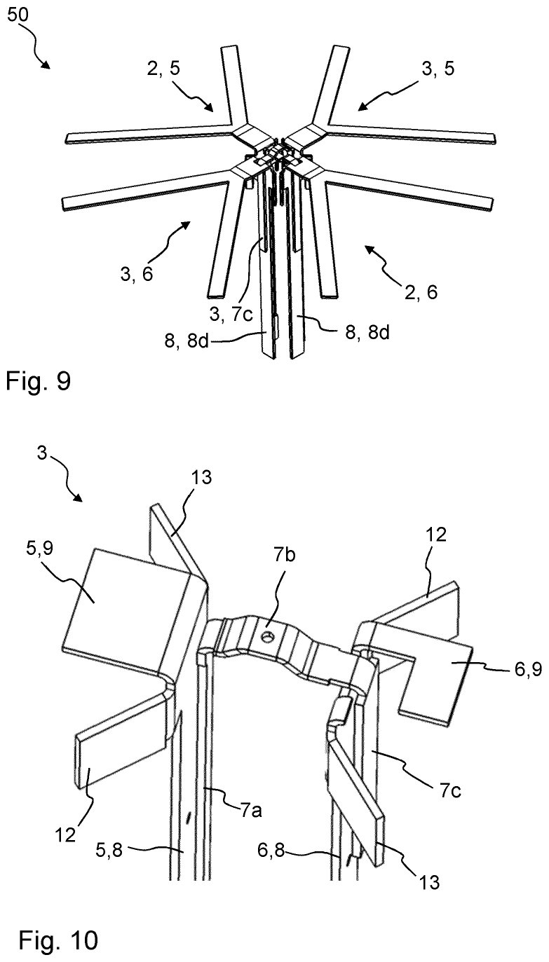

FIG. 9 shows another embodiment of the dual-polarized cross radiator 50. Entered embodiment, the wing sections 9 of the first and second carriers 5, 6 of the second dipole radiator 2, 3 bifurcated. As such, each wing section 9 comprises two aims which run apart from each other. The two arms might run apart from each other directly at the second end 8b of the respective support sections 8 of the respective first or second carrier 5, 6. However, in the depicted embodiment there is a common part beginning at the second end 8b of the support section 8. After the end of the common part, which both arms share, both arms run apart from each other.

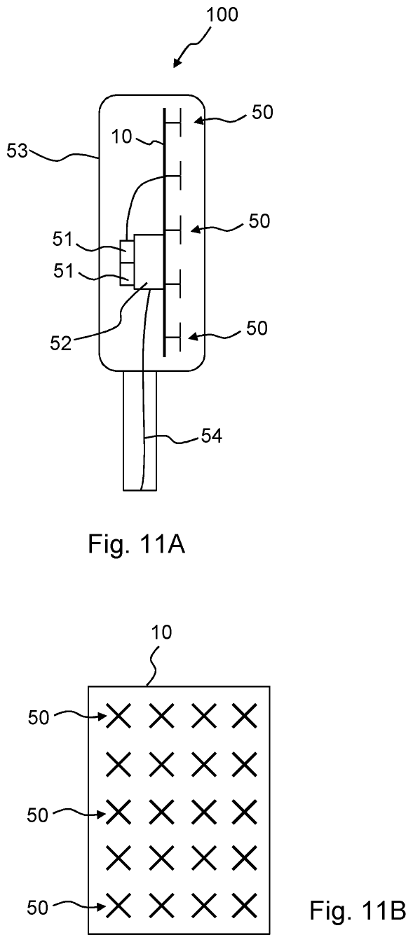

FIGS. 11A, 11B show an embodiment of the mobile communication antenna 100 comprising a plurality of dual-polarized cross dipoles 50. A base plate 10 in the form of a reflector arrangement is shown. The plurality of dual-polarized cross dipoles 50 are arranged on a first side of the reflector arrangement in n columns, with n≥2, 3, 4, 5, 6, 7, 8, wherein in each column m dual-polarized cross dipoles are provided, with m≥2, 3, 4, 5, 6, 7, 8, 12, 16, 20.

The mobile communication antenna 100 also comprises a phase shifter arrangement 51 and a filter arrangement 52. The phase shifter arrangement 51 and the filter arrangement 52 are arranged on a second side of the base plate 10 (the reflector arrangement).

The phase shifter arrangement 51 comprises at least one phase shifter for each of the two polarizations. The output of the at least one first phase shifter is connected to the feed sections 7a of the signal feeding structures 7 of the first dipole radiator 2. The output of the at least one second phase shifter are connected to the feed sections 7a of the signal feeding structures 7 of the second dipole radiator 3. There could also be more feed sections 7a connected to one output of the at least one or second phase shifter. More preferably, dual-polarized cross dipoles 50 in different kinds are connected to different first and second phase shifter. Between the phase shifter and the respective dual-polarized cross dipole 50, there could also be a matching network arranged. The common part of the phase shifter is preferably connected to the filter arrangement 52. The filter arrangement 52 comprises different filters which are configured to separate the transmission path from the receiving path. Preferably, an additional filtering is performed within the transmission path and the receiving path. More preferably, at least the receiving path is then connected to a low noise amplifier. More preferably, all receiving paths are connected to a respective low noise amplifier. It would also be possible that the transmission path is connected to a power amplifier. More preferably, all transmitting paths are connected to a respective power amplifier. Preferably, the lower noise amplifier is arranged within the mobile communication antenna 100 or on the outside (back) of the mobile communication antenna 100 but still on the mast. The same could also be true for the power amplifier. A radome 53 encloses the reflector arrangement and the plurality of dual-polarized cross dipoles 50 as well as the additional electronics (phase shifters, filtering). The mobile communication antenna 100 is connected to a base station (not shown) via one or more feeder cables 54

Preferably, the first carrier 5, the second carrier 6 and the signal feeding structure 7 of the first dipole radiator 2 are arranged in the same plane. Further preferably, the first carrier 5, the second carrier 6 and the signal feeding structure 7 of the second dipole radiator 3 are arranged in the same plane. Further preferably, both planes are aligned perpendicular to each other.

Preferably, the larger side of the surface of each wing section 9 of the respective first and second carrier 5, 6 of the first and/or second dipole radiators 2, 3 is arranged in a plane parallel or substantially parallel to the reflector arrangement but not perpendicular to the reflector arrangement (base plate 10). In other words, the wing sections 9 are fully or at least predominantly arranged in a horizontal position (regarding the reflector arrangement) and not upright.

Preferably, the surface of each wing section 9 of the respective first and second carriers 5, 6 of the first and/or second dipole radiators 2, 3 which is visible in top view is larger than a side surface of each wing section 9 of the respective first and second carriers 5, 6 of the first and/or second dipole radiators 2, 3 which is visible in side view.

Preferably, the wing section 9 of the respective first and second carriers 5, 6 of the first dipole radiator 2 is free of a coupling to another wing section 9 of the respective first and second carriers 5,6 of the second dipole radiator 3.

Preferably, the wing section 9 of the respective first and second carriers 5, 6 of the first dipole radiator 2 is arranged at an angle (not parallel) to the nearest neighboring wing section 9 of the respective first and second carriers 5, 6 of the second dipole radiator 3.

Preferably, the support sections 8 of the first and second carriers 5, 6 of the first and/or second dipole radiator 2, 3 are aligned parallel to each other.

Preferably, each wing section 9 of the respective first and second carriers 5, 6 of the first and/or second dipole radiator 2, 3 is only electrically connected and/or galvanically coupled in the region of the second end 8b of the support section 8 of the respective first and second carriers 5, 6.

Preferably, each wing section 9 is electrically connected only in a single place. Preferably, each wing section 9 is free of a solder joint. Further preferably, the first and the second dipole radiators 2, 3 are completely free of solder joints. Further preferably, the first and the second dipole radiators 2, 3 are free of solder joints except for the respective first ends 8a of the support section 8 of the first and second carriers 5, 6 and/or except for the feed section 7a of the signal feeding structure 7.

Preferably, the support section 8 of the first and/or second carrier 5, 6 of the first and/or second dipole radiator 2, 3 is made of or comprises sheet metal.

Preferably, the feed section 7a, the connecting section 7b and/or the end section 7c of the signal feeding structure 7 of the first and/or second dipole radiator 2, 3 is or are made of or comprises sheet metal.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

1. A Dipole radiator for a dual-polarized crossed dipole for a mobile communication antenna, comprising the following features:
a first and a second carrier and a signal feeding structure are provided;
the first carrier comprises a support section and a wing section, said support section having a first end and said support section is arrangeable on and extending away from a base plate and a second end merging with said wing section which extends at an angle to and away from said support section;
the second carrier comprises a support section and a wing section, said support section having a first end and said support section is arrangeable on and extending away from the base plate and a second end merging with said wing section which extends at an angle to and away from said support section;
the wing sections of the first and second carriers extend at least partially in opposite directions;
the support sections of the first and second carriers each comprise an inner side and an opposite outer side, wherein the inner sides of the support sections of the first and second carriers face each other;
the signal feeding structure comprises a feed section, a connecting section and an end section;
the feed section of the signal feeding structure extends between the support sections of the first and second carriers along the inner side of the support section of the first carrier and merges with the connection section;
the connecting section extends from the region of the second end of the support section of the first carrier towards the second end of the support section of the second carrier and merges into the end section in this region;
the end section runs along the outer side of the support section of the second carrier in the direction of its first end.

2. The Dipole radiator according to claim 1, characterized by the following feature:
a vector of an E-field between the feed section of the signal feeding structure and the support section of the first carrier points in approximately the same direction as a vector of an E-field between the end section of the signal feeding structure and the support section of the second carrier.

3. The Dipole radiator according to claim 1, characterized by the following feature:
the second carrier comprises an opening in the region of the second end of the support section through which the signal feeding structure passes.

4. The Dipole radiator according to claim 3, characterized by the following feature:
the opening is bounded in the circumferential direction by the second carrier and is thus closed; or
the opening is open to one side so that the signal feeding structure is insertable into the opening with a movement vector transverse to the extension of the support section of the second carrier.

5. The Dipole radiator according to claim 1, characterized by the following feature:
the feed section of the signal feeding structure is longer than the end section of the signal feeding structure.

6. The Dipole radiator according to claim 1, characterized by the following feature:
the signal feeding structure is a punched and/or lasered and/or bent part; and/or
the first carrier is a punched and/or lasered and/or bent part; and/or
the second carrier is a punched and/or lasered and/or bent part.

7. The Dipole radiator according to claim 1, characterized by the following feature:
the support section of the first carrier is wider along its predominant length than the feed section of the signal feeding structure; and/or
the support section of the second carrier is wider along its predominant length than the end section of the signal feeding structure.

8. The Dipole radiator according to claim 1, characterized by the following feature:
the feed section of the signal feeding structure comprises segments with a different width.

9. The Dipole radiator according to claim 1, characterized by the following feature:
a part of the wing section of the first carrier comprises a printed circuit board or a metallized substrate; and/or
a part of the wing section of the second carrier comprises a printed circuit board or a metallized substrate.

10. The Dipole radiator according to claim 1, characterized by the following feature:
the wing section of the first carrier is bifurcated; and/or
the wing section of the second carrier is bifurcated.

11. A Dual-polarized cross dipole for mobile communication antennas, wherein the dual-polarized cross dipole comprises a first dipole radiator and a second dipole radiator characterized by the following features:
the second dipole radiator is arranged 90° rotated with respect to the first dipole radiator, whereby the support sections of the first and second carriers of the first dipole radiator are arranged 90° rotated with respect to the support sections of the first and second carriers of the second dipole radiator;
the connecting section of the signal feeding structure of the first dipole radiator passes under the connecting section of the signal feeding structure of the second dipole radiator; or
the connecting section of the signal feeding structure of the second dipole radiator passes under the connecting section of the signal feeding structure of the first dipole radiator.

12. The Dual-polarized cross dipole according to claim 11, characterized by the following features:
the first and second carriers of the first dipole radiator and the first and second carriers of the second dipole radiator comprise at least two coupling surfaces in the region of the second end of their respective support section;
the coupling surfaces extend from the region of the second end of the respective support section partly in the direction of the first end of the respective support section;
the coupling surfaces are arranged on the two opposite sides of the respective first and second carrier and are angularly aligned with respect to this first and second carrier;
a first coupling surface of the first carrier of the first dipole radiator extends spaced apart and at least partially parallel and adjacent to a first coupling surface of the first carrier of the second dipole radiator, thereby forming a capacitive coupling between both coupling surfaces;
a second coupling surface of the first carrier of the first dipole radiator extends spaced apart and at least partially parallel and adjacent to a second coupling surface of the second carrier of the second dipole radiator, thereby forming a capacitive coupling between both coupling surfaces;
a first coupling surface of the second carrier of the first dipole radiator extends spaced apart and at least partially parallel and adjacent to a first coupling surface of the second carrier of the second dipole radiator, thereby forming a capacitive coupling between both coupling surfaces;
a second coupling surface of the second carrier of the first dipole radiator extends spaced apart and at least partially parallel and adjacent to a second coupling surface of the first carrier of the second dipole radiator, thereby forming a capacitive coupling between both coupling surfaces.

13. The Dual-polarized cross dipole according to claim 12, characterized by the following feature:
some or all of the coupling surfaces comprise coupling fingers at their ends remote from the central axis, the coupling fingers of two adjacent coupling surfaces being bent towards each other and engaging into each other without contact.

14. The Dual-polarized cross dipole according to claim 12, characterized by the following features:
a holding device is provided;
the holding device comprises:
a) a ground part attachable to a base plate and configured to support the first and second carriers of the first and second dipole radiators in the region of the first end of their respective support sections; and/or
b) a head part configured to hold the first and second carriers of the first and second dipole radiators in the region of the second end of their respective support sections, wherein the head part comprises coupling elements which are each inserted between two adjacent coupling surfaces of different dipole radiators to affect the capacitive coupling.

15. The Dual-polarized cross dipole according to claim 11, characterized by the following features:
the support sections of the first and second carriers of the first dipole radiator are joined together at their first ends and are formed in one-piece; and/or
the support sections of the first and second carriers of the second dipole radiator are connected to each other at their first ends and are formed in one-piece; or
the support section of the first carrier of the first dipole radiator is integrally connected at the first end to the first end of the support section of the first or second carrier of the second dipole radiator, respectively; and/or
the support section of the second carrier of the first dipole radiator is integrally connected at the first end to the first end of the support section of the second or first carrier of the second dipole radiator; or
the support sections of the first and second dipole radiators are all integrally connected to each other at their first ends.

16. A Mobile communication antenna having a plurality of dual-polarized cross dipoles comprising the following features:
a reflector arrangement;
the plurality of dual-polarized cross dipoles are arranged on a first side of the reflector arrangement in n columns, with n≥2, 3, 4, 5, 6, 7, 8, wherein in each column m dual-polarized cross dipoles are provided, with m≥2, 3, 4, 5, 6, 7, 8, 12, 16, 20;
a phase shifter arrangement and a filter arrangement are arranged on a second side of the reflector arrangement.
